(19) United States
(12) Patent Application Publication
(10) Pub. No.: US 2006/0210951 A1
(43) Pub. Date: Sep. 21, 2006

(54) Dynamic technique for fitting dentures to individuals

(75) Inventors: Menachem Levanoni, Poway, CA (US); Jerome M. Kurtzberg, Yorktown Heights, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/082,666

(22) Filed: Mar. 17, 2005

(51) Int. Cl. A61C 11/00

(52) U.S. Cl. 433/213

(57) ABSTRACT

A method comprising the steps of mounting pressure sensors in a tooth-enclosing device; transmitting data produced by pressure sensors during actual operation of said tooth-enclosing device worn by a specific individual; receiving said sensor signals for subsequent analysis by a computer; creating a stress-map based on said sensor-based data; and creating a virtual denture (model) for optimal support and comfort based on the stress-map.

### CROSS REFERENCE TO RELATED APPLICATIONS

The instant application is related to U.S. application Ser. No. ______, filed ______, 2005 by Levanoni, et al.; and the U.S. application Ser. No. ______ filed ______, 2005 by Levanoni, et al. These applications are co-pending, commonly assigned, and incorporated by reference herein.

### BACKGROUND OF THE INVENTION

1. Field of the Invention

This invention relates to methodology for utilizing continual sensor-based data to design and adjust dentures to fit an individual, in a given dynamic environment, in an efficient manner.

2. Introduction to the Invention

Static fitting techniques to design and construct dentures for specific people are known. A plaster cast is taken and the denture is produced based on that plastic impression.

### SUMMARY OF THE INVENTION

However, in this context, we have discerned that no attention is given to the dynamic workings of the tooth in the changing real environment. Specifically, the stresses and strains experienced by the tooth during normal operation are not taken into account, nor is the optimum balance, between support and comfort, taken into account.

We have now discovered novel methodology for exploiting the advantages inherent generally in sensing the dynamic workings (stresses) on specific teeth in actual motion, and using the sensor-based data to optimize the design and construction of the desired dentures.

Our work proceeds in the following way.

We have recognized that a typical and important paradigm for presently effecting dentures construction, is a largely static and subjective, human paradigm, and therefore exposed to all the vagaries and deficiencies otherwise attendant on static and human procedures. Instead, the novel paradigm we have in mind, works in the following way:

First, a patient wears a set of pressure and sensors mounted, say, inside a tooth-encasing device (harness). These sensors record their associated stesses and strains produced in normal individual motion in its dynamic environment for a prescribed period of time sufficient to capture all possible stress and strain patterns.

The dynamically acquired data are fed into a computer which creates a map of the forces and stresses experienced by the examined tooth. This information is used to design an optimal denture which maximizes support and minimizes discomfort, and results in a computer production of a virtual dentures that offers optimal performance to the examined tooth in its normal operation.

A physical denture may then be produced from a model provided by the virtual denture. This physical denture can provide maximum support and maximal comfort to its wearer, following the optimal design of the denture.

We now disclose a novel method which can preserve the advantages inherent in the static approach, while minimizing the incompleteness and attendant static nature and subjectivities that otherwise inure in a technique heretofore used.

To this end, in a first aspect of the present invention, we disclose a novel method comprising the steps of:

i) mounting pressure sensors in a tooth-enclosing device;

ii) transmitting data produced by said sensors during actual operation of said tooth-enclosing device worn by a specific individual;

iii) receiving said sensor signals for subsequent analysis by a computer;

iv) creating a stress-map based on said sensor-based data;

and

v) creating a virtual denture (model) for optimal support and comfort based on step iv stress-map.

The novel method preferably comprises, a further step of actual construction of said physical denture.

### BRIEF DESCRIPTION OF THE DRAWINGS

The invention is illustrated in the accompanying drawing, in which

FIG. 1 provides an illustrative flowchart comprehending overall realization of the method of the present invention.

### DETAILED DESCRIPTION OF THE PRESENT INVENTION

Typical Application

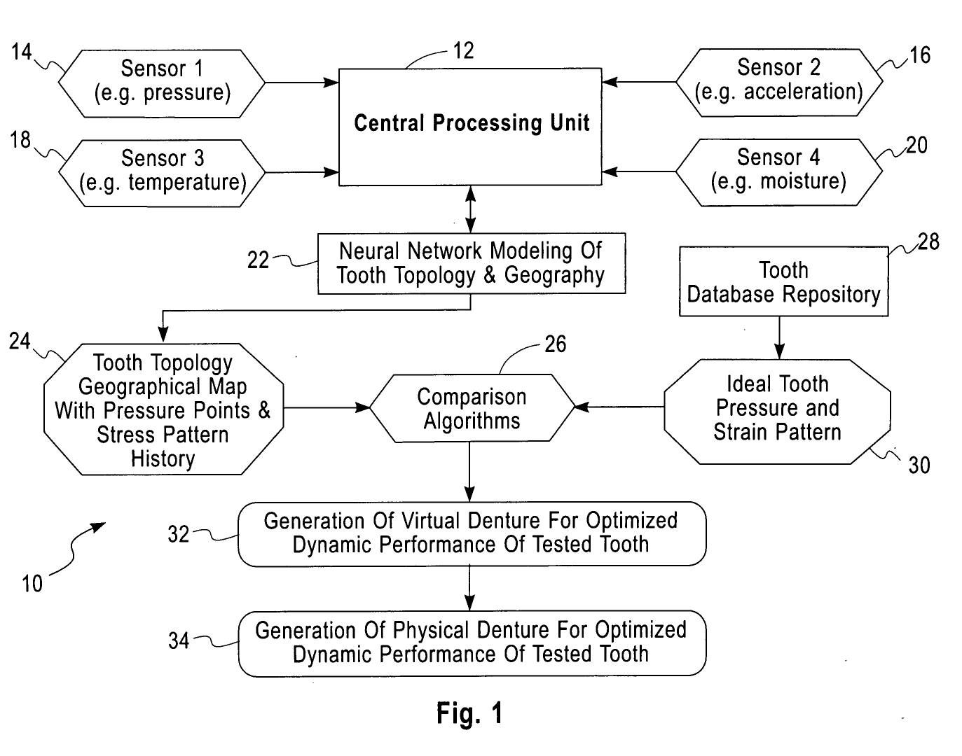

Attention is now directed to FIG. 1, numerals 10-34.

In a typical case, the patient's tooth is fitted with a temporary harness containing a number of sensors, located at prescribed locations on the tested tooth. These sensors, which preferably include pressure, temperature and humidity, are connected to a recording device.

The patient is asked to wear the harness for several days and follow his/her normal routine.

During the test period, sensor data are recorded (including time stamps) in the recording device. The patient returns the harness and the recording device at the end of the test period. The information stored in the recording device is then downloaded to a computer which stores all data in a database.

The data are then analyzed by a program (prefearably a neural network modeling program) which creates maps of the tested tooth at different times. These maps also contains the sensors' reading at these times. Thus, the system now has information on the dynamic behavior of the tested tooth, including parametric information.

Based on these maps and maps of an ideal tooth under similar conditions, an optimization program designs an optimized virtual denture for the patient. This design is then fed to a machine which generates an optimized physical denture.

What is claimed:

1. A method comprising the steps of:
i) mounting pressure sensors in a tooth-enclosing device;
ii) transmitting data produced by pressure sensors during actual operation of said tooth-enclosing device worn by a specific individual;
iii) receiving said sensor signals for subsequent analysis by a computer;
iv) creating a stress-map based on said sensor-based data; and
v) creating a virtual denture (model) for optimal support and comfort based on step iv stress-map.

2. A method according to claim 1, comprising a step of using at least one of temperature, moisture, and skin conductivity sensors which may be correlated with support and comfort of a worn denture.

3. A method according to claim 1, comprising a step of using interpolation techniques to completely map stresses experienced by a tooth over a period of time.

4. A method according to claim 3, comprising a step of updating the virual denture model using the interpolating map.

5. A method according to claim 1, comprising a step of using linear or non-linear techniques to model an optimal denture.

6. A method according to claim 5, comprising a step of employing neural networks as the modeling technique.

7. A method according to claim 6, comprising a step of employing regression as the modeling technique.
